(19) United States
(12) Patent Application Publication
(10) Pub. No.: US 2025/0184836 A1
(43) Pub. Date: Jun. 5, 2025

(54) METHODS AND APPARATUSES OF A MRO MECHANISM FOR SPAR OR SPCR AND SCG FAILURE INFORMATION PROCEDURE

(71) Applicant: Lenovo (Beijing) Limited, Beijing (CN)

(72) Inventors: Lianhai Wu, Beijing (CN); Le Yan, Shanghai (CN); Mingzeng Dai, Shanghai (CN); Jing Han, Beijing (CN); Ran Yue, Beijing (CN)

(73) Assignee: Lenovo (Beijing) Limited, Beijing (CN)

(21) Appl. No.: 18/721,844

(22) PCT Filed: Dec. 10, 2021
(86) PCT No.: PCT/CN2021/137104

§ 371 Date: Jun. 19, 2024

(51) Int. Cl. H04W 36/00; H04W 36/30; H04W 36/36; H04W 76/20

(52) U.S. Cl. CPC H04W 36/0061; H04W 36/0058; H04W 36/305; H04W 36/362; H04W 76/20

(57) ABSTRACT

Embodiments of the present application relate to methods and apparatuses of a mobility robustness optimization (MRO) mechanism for a successful primary cell of a second cell group (PSCell) addition report (SPAR) or a successful PSCell change report (SPCR) and a secondary cell group (SCG) failure information procedure. According to an embodiment of the present application, a user equipment (UE) includes a processor and a transceiver coupled to the processor; and the processor is configured: to receive, via the transceiver from a MN, configuration information regarding a PSCell addition or change procedure, wherein the configuration information includes a trigger condition to transmit assistant information, and wherein the assistant information is related to successfully completing the PSCell addition or change procedure; and to transmit the assistant information via the transceiver to at least one of the MN, a source SN, or a target SN, in response to successfully completing the PSCell addition or change procedure and in response to meeting the trigger condition.

### TECHNICAL FIELD

Embodiments of the present application generally relate to wireless communication technology, in particular to methods and apparatuses of a mobility robustness optimization (MRO) mechanism for a successful primary cell of a second cell group (PSCell) addition report (SPAR) or a successful PSCell change report (SPCR) and a secondary cell group (SCG) failure information procedure.

### BACKGROUND

A base station (BS) can have some cells (or areas) to provide communication service. When a user equipment (UE) moves from a serving cell of a source BS to a target cell of a target BS, a handover procedure is performed. When a radio link failure (RLF) or a handover (HO) failure occurs for a UE, the UE may perform a radio resource control (RRC) re-establishment procedure. The UE may access a cell by a successful RRC re-establishment procedure. The accessed network will request UE information including a RLF-report of the UE, such that the network can optimize the mobility problem based on the UE information from the UE. Accordingly, the UE will transmit a failure report to the network.

A MRO mechanism is to detect connection failure(s) that occur due to Too Early or Too Late Handovers, or Handover to Wrong Cell. The general procedure is that after a RLF or a HO failure happens, a UE access a new cell by RRC re-establishment or connection setup procedure. Once the UE enters a connected state, the UE transmits a RLF-report and a RACH report to the serving cell. The serving cell will transmit a failure indication including the RLF-report to the last serving cell. Finally, the information is used to optimize the mobility.

3rd Generation Partnership Project (3GPP) 5G networks are expected to increase network throughput, coverage, and robustness and reduce latency and power consumption. With the development of 3GPP 5G networks, various aspects need to be studied and developed to perfect the 5G technology. Currently, details regarding a MRO mechanism for a SPAR or a SPCR and SCG failure information procedure have not been discussed in 3GPP 5G technology yet.

### SUMMARY

Some embodiments of the present application provide a method, which may be performed by a UE. The method includes: receiving, from a master node (MN), configuration information regarding a primary cell of a second cell group (PSCell) addition or change procedure, wherein the configuration information includes a trigger condition to transmit assistant information, and wherein the assistant information is related to successfully completing the PSCell addition or change procedure; and transmitting the assistant information to at least one of the MN, a source secondary node (SN), or a target SN, in response to successfully completing the PSCell addition or change procedure and in response to meeting the trigger condition.

In some embodiments, the PSCell addition or change procedure includes at least one of: a PSCell addition procedure; a conditional PSCell addition (CPA) procedure; a PSCell change procedure; a MN initiated conditional PSCell change (CPC) procedure; or a SN initiated CPC procedure.

In some embodiments, in response to the configuration information regarding at least one of the PSCell addition procedure, the CPA procedure, or the MN initiated CPC procedure: a 1st threshold associated with a handover timer for the trigger condition is configured by the target SN; or a 2nd threshold associated with a physical layer problem timer for the trigger condition is configured by the MN; or a 3rd threshold associated with a timer for initiating failure recovery based on triggering measurement report for the trigger condition is configured by the MN. In some embodiments, at least one of the abovementioned thresholds is a percent value of a timer length.

In some further embodiments, in response to the configuration information regarding the SN initiated CPC procedure: a 4th threshold associated with a physical layer problem timer for the trigger condition is configured by the source SN; or a 5th threshold associated with a timer for initiating failure recovery based on triggering measurement report for the trigger condition is configured by the source SN; or a 6th threshold associated with a handover timer for the trigger condition is configured by the target SN; or a 7th threshold associated with the physical layer problem timer for the trigger condition is configured by the MN; or a 8th threshold associated with the timer for initiating failure recovery for the trigger condition is configured by the MN.

In some embodiments, at least one of the abovementioned thresholds is a percent value of a timer length.

In some embodiments, the trigger condition to transmit assistant information includes at least one of: an elapsed time duration of the handover timer exceeds the abovementioned 1st threshold multiplied by a length of the handover timer; an elapsed time duration of the physical layer problem timer exceeds the abovementioned 2nd threshold multiplied by a length of the physical layer problem timer; an elapsed time duration of the timer for initiating failure recovery exceeds the abovementioned 3rd threshold multiplied by a length of the timer for initiating failure recovery; the elapsed time duration of the physical layer problem timer exceeds the abovementioned 4th threshold multiplied by the length of the physical layer problem timer; the elapsed time duration of the timer for initiating failure recovery exceeds the abovementioned 5th threshold multiplied by the length of the timer for initiating failure recovery; the elapsed time duration of the handover timer exceeds the abovementioned 6th threshold multiplied by the length of the handover timer; the elapsed time duration of the physical layer problem timer exceeds the abovementioned 7th threshold multiplied by the length of the physical layer problem timer; the elapsed time duration of the timer for initiating failure recovery exceeds the abovementioned 8th threshold multiplied by the length of the timer for initiating failure recovery; an expiry of the handover timer; an expiry of the physical layer problem timer; an expiry of the timer for initiating failure recovery; or the elapsed time duration of the physical layer problem timer after initiating a SCG failure information procedure exceeds another threshold multiplied by the length of the physical layer problem timer.

In some embodiments, in response to “the configuration information including the trigger condition to transmit the assistant information” configured by the source SN, the configuration information including the trigger condition is received by the MN from the source SN via a SN change required message. In some other embodiments, in response to “the configuration information including the trigger condition to transmit the assistant information” configured by the target SN, the configuration information including the trigger condition is received by the MN from the target SN via a SN addition request acknowledge message.

In some embodiments, the method further comprises: transmitting, to the MN, information indicating which trigger condition having been met in response to meeting at least one trigger condition in the configuration information. In an embodiment, the information is carried in a RRC reconfiguration complete message.

In an embodiment, the information includes at least one of: information indicating that a trigger condition related to a physical layer problem timer has been met for a SPAR or a SPCR, in response to meeting the trigger condition related to the physical layer problem timer; or information indicating that a trigger condition related to a timer for initiating failure recovery based on triggering measurement report has been met for the SPAR or the SPCR, in response to meeting the trigger condition related to the timer for initiating failure recovery.

In some embodiments, the method further comprises receiving a request from the MN, wherein the request includes information indicating that a SPAR or a SPCR should be reported. In an embodiment, the request may be carried in a UE information request message. In some embodiments, the assistant information is transmitted in a response to the MN, and the assistant information includes the SPAR or the SPCR. In an embodiment, the response is carried in a UE information response message.

In some embodiments, the method further includes: transmitting, to the target SN, information indicating that a SPAR or a SPCR is available. In some embodiments, the method further includes: receiving a request for the SPAR or the SPCR from the target SN; and transmitting the SPAR or the SPCR to the target SN, in response to receiving the request from the target SN.

Some embodiments of the present application also provide a UE. The UE includes a processor and a transceiver coupled to the processor; and the processor is configured: to receive, via the transceiver from a MN, configuration information regarding a PSCell addition or change procedure, wherein the configuration information includes a trigger condition to transmit assistant information, and wherein the assistant information is related to successfully completing the PSCell addition or change procedure; and to transmit the assistant information via the transceiver to at least one of the MN, a source SN, or a target SN, in response to successfully completing the PSCell addition or change procedure and in response to meeting the trigger condition.

Some embodiments of the present application provide a method, which may be performed by a UE. The method includes: initiating a SCG failure information procedure; and transmitting, to a MN, at least one of “information which indicates whether a physical layer problem timer is running” or “information which indicates whether a timer for initiating failure recovery based on triggering measurement report is running”.

In some embodiments, the method further includes: transmitting, to the MN, an elapsed time duration of the physical layer problem timer after initiating the SCG failure information procedure, in response to the physical layer problem timer running; or transmitting, to the MN, an elapsed time duration of the timer for initiating failure recovery after initiating the SCG failure information procedure, in response to the timer for initiating failure recovery running.

Some embodiments of the present application also provide a UE. The UE includes a processor and a transceiver coupled to the processor; and the processor is configured: to initiate a SCG failure information procedure; and to transmit SCG failure information message, via the transceiver to a MN, wherein the SCG failure information message includes at least one of “information which indicates whether a physical layer problem timer is running” or “information which indicates whether a timer for initiating failure recovery based on triggering measurement report is running”.

Some embodiments of the present application provide a method, which may be performed by a network node (e.g., a MN). The method includes: transmitting to a UE, configuration information regarding a PSCell addition or change procedure, wherein the configuration information includes a trigger condition to transmit assistant information, and wherein the assistant information is related to successfully completing the PSCell addition or change procedure; and receiving the assistant information from the UE, in response to successfully completing the PSCell addition or change procedure and in response to meeting the trigger condition.

In some embodiments, the method further includes: receiving the configuration information including the trigger condition from a source SN or a target SN, before transmitting the configuration information.

In some embodiments, in response to the configuration information configured by the source SN, the configuration information is received by the MN from the source SN via a SN change required message. In some other embodiments, in response to the configuration information configured by the target SN, the configuration information is received by the MN from the target SN via a SN addition request acknowledge message.

In some embodiments, the PSCell addition or change procedure includes at least one of: a PSCell addition procedure; a CPA procedure; a PSCell change procedure; a MN initiated CPC procedure; or a SN initiated CPC procedure.

In some embodiments, in response to the configuration information regarding at least one of the PSCell addition procedure, the CPA procedure, or the MN initiated CPC procedure: a 1st threshold associated with a handover timer for the trigger condition is configured by a target SN; or a 2nd threshold associated with a physical layer problem timer for the trigger condition is configured by the MN; or a 3rd threshold associated with a timer for initiating failure recovery based on triggering measurement report for the trigger condition is configured by the MN. In some embodiments, at least one of the abovementioned thresholds is a percent value of a timer length.

In some further embodiments, in response to the configuration information regarding the SN initiated CPC procedure: a 4th threshold associated with a physical layer problem timer for the trigger condition is configured by a source SN; or a 5th threshold associated with a timer for initiating failure recovery based on triggering measurement report for the trigger condition is configured by the source SN; or a 6th threshold associated with a handover timer for the trigger condition is configured by a target SN; or a 7th threshold associated with the physical layer problem timer for the trigger condition is configured by the MN; or a 8th threshold associated with the timer for initiating failure recovery for the trigger condition is configured by the MN. In some embodiments, at least one of the abovementioned thresholds is a percent value of a timer length.

In some embodiments, the trigger condition to transmit assistant information includes at least one of: an elapsed time duration of the handover timer exceeds the abovementioned 1st threshold multiplied by a length of the handover timer; an elapsed time duration of the physical layer problem timer exceeds the abovementioned 2nd threshold multiplied by a length of the physical layer problem timer; an elapsed time duration of the timer for initiating failure recovery exceeds the abovementioned 3rd threshold multiplied by a length of the timer for initiating failure recovery; the elapsed time duration of the physical layer problem timer exceeds the abovementioned 4th threshold multiplied by the length of the physical layer problem timer; the elapsed time duration of the timer for initiating failure recovery exceeds the abovementioned 5th threshold multiplied by the length of the timer for initiating failure recovery; the elapsed time duration of the handover timer exceeds the abovementioned 6th threshold multiplied by the length of the handover timer; the elapsed time duration of the physical layer problem timer exceeds the abovementioned 7th threshold multiplied by the length of the physical layer problem timer; the elapsed time duration of the timer for initiating failure recovery exceeds the abovementioned 8th threshold multiplied by the length of the timer for initiating failure recovery; an expiry of the handover timer; an expiry of the physical layer problem timer; an expiry of the timer for initiating failure recovery; or the elapsed time duration of the physical layer problem timer after initiating a SCG failure information procedure exceeds another threshold multiplied by the length of the physical layer problem timer.

In some embodiments, the method further includes: receiving, from the UE, information indicating which trigger condition having been met in response to meeting at least one trigger condition in the configuration information. In some embodiments, the information includes at least one of: information indicating that a trigger condition related to a physical layer problem timer has been met for a SPAR or a SPCR, in response to meeting the trigger condition related to the physical layer problem timer; or information indicating that a trigger condition related to a timer for initiating failure recovery based on triggering measurement report has been met for the SPAR or the SPCR, in response to meeting the trigger condition related to the timer for initiating failure recovery.

In some embodiments, the method further includes: transfering the information to a SN during a SN initiated PSCell change procedure or a SN initiated conditional PSCell change (CPC) procedure.

In some embodiments, the method further includes: transmitting a request to the UE, wherein the request includes information indicating that a SPAR or a SPCR should be reported. In some embodiments, the request is carried in a UE information request message. In some embodiments, the assistant information is received in a response from the UE, and the assistant information includes the SPAR or the SPCR. In some embodiments, the response is carried in a UE information response message.

In some embodiments, the method further includes: receiving, from a source SN, a request indicating that a SPAR or a SPCR should be reported; and transfering the request to the UE. In some embodiments, the assistant information is received from the UE during a SN initiated PSCell change procedure or a SN initiated CPC procedure, wherein the assistant information includes the SPAR or the SPCR; and the method further includes transfering the assistant information to the source SN.

Some embodiments of the present application also provide a network node (e.g., a MN). The network node includes a processor and a transceiver coupled to the processor; and the processor is configured: to transmit, via the transceiver to a UE, configuration information regarding a PSCell addition or change procedure, wherein the configuration information includes a trigger condition to transmit assistant information, and wherein the assistant information is related to successfully completing the PSCell addition or change procedure; and to receive the assistant information via the transceiver from the UE, in response to successfully completing the PSCell addition or change procedure and in response to meeting the trigger condition.

Some embodiments of the present application provide a method, which may be performed by a source network node (e.g., a source SN). The method includes: generating configuration information regarding a PSCell change procedure, wherein the configuration information includes a trigger condition to transmit assistant information, and wherein the assistant information is related to successfully completing the PSCell change procedure; and transmitting the configuration information to a UE via a MN.

In some embodiments, the PSCell change procedure includes at least one of: a PSCell change procedure; or a SN initiated CPC procedure. In some embodiments, a 1st threshold associated with a physical layer problem timer for the trigger condition is configured by the source SN; or a 2nd threshold associated with a timer for initiating failure recovery based on triggering measurement report for the trigger condition is configured by the source SN. In some embodiments, at least one of these two thresholds is a percent value of a timer length.

In some embodiments, the trigger condition to transmit assistant information includes at least one of: an elapsed time duration of the physical layer problem timer exceeds the abovementioned 1st threshold multiplied by a length of the physical layer problem timer; an elapsed time duration of the timer for initiating failure recovery exceeds the abovementioned 2nd threshold multiplied by a length of the timer for initiating failure recovery; an expiry of the physical layer problem timer; an expiry of the timer for initiating failure recovery; or the elapsed time duration of the physical layer problem timer after initiating a SCG failure information procedure exceeds another threshold multiplied by the length of the physical layer problem timer.

In some embodiments, the method further includes: receiving the assistant information, in response to successfully completing the PSCell change procedure and in response to meeting the trigger condition.

In some embodiments, the configuration information including the trigger condition is transmitted to a UE, and the assistant information is received from the UE. In some other embodiments, the configuration information including the trigger condition is transmitted to a MN, and the assistant information is received from the MN. In response to the configuration information transmitted to the MN, the configuration information may be carried in a SN change required message.

In some embodiments, the method further includes receiving information from a MN, wherein the information indicates that a trigger condition related to a SPCR has been met. In some embodiments, the method further includes transmitting a request to the MN, wherein the request includes information indicating that the SPCR should be reported. The request may be carried in a UE information request message. In some embodiments, the assistant information is received in a response from the MN, and the assistant information includes the SPCR. The response may be carried in a UE information response message.

Some embodiments of the present application also provide a source network node (e.g., a source SN). The source network node includes a processor and a transceiver coupled to the processor; and the processor is configured: to generate configuration information regarding a PSCell change procedure, wherein the configuration information includes a trigger condition to transmit assistant information, and wherein the assistant information is related to successfully completing the PSCell change procedure; and to transmit the configuration information via the transceiver to a UE via a MN.

Some embodiments of the present application provide a method, which may be performed by a target network node (e.g., a target SN). The method includes: generating configuration information regarding a PSCell addition or change procedure, wherein the configuration information includes a trigger condition to transmit assistant information, and wherein the assistant information is related to successfully completing the PSCell addition or change procedure; and transmitting the configuration information to at least one of a UE or a MN. In some embodiments, the configuration information is carried in a SN addition request acknowledge message.

In some embodiments, the PSCell addition or change procedure includes at least one of: a PSCell addition procedure; a CPA procedure; a PSCell change procedure; a MN initiated CPC procedure; or a SN initiated CPC procedure.

In some embodiments, the trigger condition is related to a threshold associated with a handover timer. The threshold may be a percent value of a timer length. In some embodiments, the trigger condition to transmit assistant information includes at least one of: an elapsed time duration of the handover timer exceeds the threshold multiplied by the length of the handover timer; or an expiry of the handover timer.

In some embodiments, the method further includes receiving the assistant information from the UE, in response to successfully completing the PSCell addition or change procedure and in response to meeting the trigger condition.

In some embodiments, the method further includes receiving, from the UE, information indicating that a trigger condition related to a SPCR or a SPAR has been met. In some embodiments, the method further includes transmitting a request to the UE, wherein the request includes information indicating that the SPCR or the SPAR should be reported. The request may be carried in a UE information request message. In some embodiments, the assistant information is received in a response from the UE, and the assistant information includes the SPCR or the SPAR. The response may be carried in a UE information response message.

Some embodiments of the present application also provide a target network node (e.g., a target SN). The target network node includes a processor and a transceiver coupled to the processor; and the processor is configured: to generate configuration information regarding a PSCell addition or change procedure, wherein the configuration information includes a trigger condition to transmit assistant information, and wherein the assistant information is related to successfully completing the PSCell addition or change procedure; and to transmit the configuration information via the transceiver to at least one of a UE or a MN.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement any of the abovementioned methods performed by UE or a network node (e.g., a MN, a source SN, or a target SN).

The details of one or more examples are set forth in the accompanying drawings and the descriptions below. Other features, objects, and advantages will be apparent from the descriptions and drawings, and from the claims. Persons skilled in the art should well know that the wording “a/the first,” “a/the second” and “a/the third” etc. are only used for clear description, and should not be deemed as any substantial limitation, e.g., sequence limitation.

### BRIEF DESCRIPTION OF THE DRAWINGS

In order to describe the manner in which advantages and features of the application can be obtained, a description of the application is rendered by reference to specific embodiments thereof, which are illustrated in the appended drawings.

These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary SCG failure information procedure in accordance with some embodiments of the present application.

FIG. 3 illustrates an exemplary UE information procedure in accordance with some embodiments of the present application.

FIG. 4 illustrates an exemplary failure indication procedure in accordance with some embodiments of the present application.

FIG. 5 illustrates an exemplary access and mobility indication procedure in accordance with some embodiments of the present application.

FIG. 6 illustrates an exemplary block diagram of an apparatus according to some embodiments of the present application.

FIG. 7 illustrates a further exemplary flow chart of a report for PSCell addition and conditional PSCell addition procedures according to some embodiments of the present application.

FIG. 8 illustrates a further exemplary flow chart of a MN initiated SN change procedure according to some embodiments of the present application.

FIG. 9 illustrates a further exemplary flow chart of a SN initiated SN change procedure according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

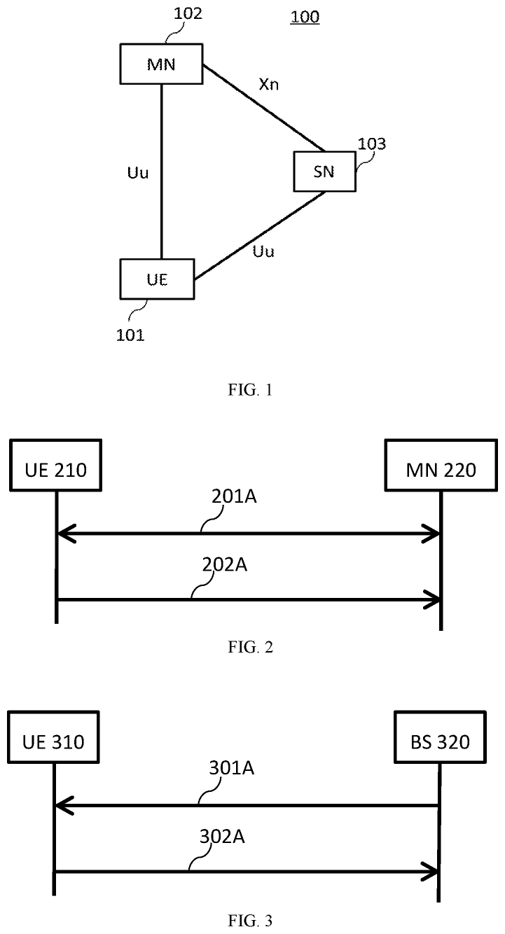

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a MCG. The MCG may refer to a group of serving cells associated with MN 102, and may include a primary cell (PCell) and optionally one or more SCells of the MCG The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a SCG. The SCG may refer to a group of serving cells associated with SN 103, and may include a primary secondary cell (PSCell) and optionally one or more SCells. The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE 101 may include wearable devices, such as smart watches, fitness bands, optical head-mounted displays, or the like.

Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In general, the purpose of a SCG failure information procedure is to inform MN about an SCG failure which UE has experienced, i.e., a SCG radio link failure, a failure of SCG reconfiguration with sync, a SCG configuration failure for RRC message on signaling radio bearer (SRB) 3, and a SCG integrity check failure. The UE initiates a SCG failure information procedure to report SCG failure(s) when neither MCG nor SCG transmission is suspended and when at least one of following conditions is met:
(1) upon detecting a RLF for the SCG;
(2) upon a reconfiguration with sync failure of the SCG;
(3) upon a SCG configuration failure; or
(4) upon an integrity check failure indication from SCG lower layer(s) concerning SRB3.

FIG. 2 illustrates an exemplary SCG failure information procedure in accordance with some embodiments of the present application. The embodiments of FIG. 2 show a procedure of a UE (e.g., UE 210) communicating with a MN (e.g., MN 220). In some examples, UE 210 may function as UE 101 in FIG. 1. MN 220 may function as MN 102 in FIG. 1.

As shown in FIG. 2, in operation 201A, UE 210 and MN 220 perform a RRC reconfiguration procedure. Upon initiating a SCG failure information procedure, UE 210 shall suspend SCG transmission for all SRB(s), data radio bearer(s) (DRB)(s), and, if any, backhaul (BH) radio link control (RLC) channels and transmit SCGFailureInformation message. In operation 202A as shown in FIG. 2, UE 210 transmits SCGFailureInformation message to MN 220. The message may include failureType and measurement results.

In general, one of the functions of MRO mechanism is to detect connection failures that occur due to “Too Early” or “Too Late Handovers”, or “Handover to Wrong Cell”. These problems are defined as follows:
(1) [Intra-system Too Late Handover] An RLF occurs after the UE has stayed for a long period of time in the cell; the UE attempts to re-establish the radio link connection in a different cell.
(2) [Intra-system Too Early Handover] An RLF occurs shortly after a successful handover from a source cell to a target cell or a handover failure occurs during the handover procedure; the UE attempts to re-establish the radio link connection in the source cell.
(3) [Intra-system Handover to Wrong Cell] An RLF occurs shortly after a successful handover from a source cell to a target cell or a handover failure occurs during the handover procedure; the UE attempts to re-establish the radio link connection in a cell other than the source cell and the target cell.

In the definition above, the “successful handover” refers to the UE's state, namely, the successful completion of the radio access (RA) procedure.

After a RLF or a handover failure occurs, UE will perform a re-establishment procedure in a cell. The UE will store some information related with the RLF failure and/or handover information. The UE stores the latest RLF-report, including both LTE and NR RLF-report until the RLF-report is fetched by a network node or for 48 hours after the connection failure is detected. For analysis of connection failures, the UE makes the RLF-report available to the network node.

In general, a UE information procedure is used by a network node to request the UE to report information. After the network node receives the information indicating that RLF information or RA failure information is available, the network node may transmit UEInformationRequest message to the UE, which includes a RLF-report request and/or a RA-report request. Once the UE receives the request from the network node, the UE will transmit UEInformationResponse message including RLF-report and/or RA-report to the network node.

FIG. 3 illustrates an exemplary UE information procedure in accordance with some embodiments of the present application. The embodiments of FIG. 3 show a procedure of a UE (e.g., UE 310) communicating with a BS (e.g., BS 320). In some examples, UE 310 may function as UE 101 in FIG. 1. BS 320 may function as MN 102 or SN 103 in FIG. 1.

As shown in FIG. 3, in operation 301A, BS 320 (e.g., MN 102 as illustrated and shown in FIG. 1) transmits UEInformationRequest message to UE 210 (e.g., UE 101 as illustrated and shown in FIG. 1). BS 320 may be a source BS which controls a serving cell of UE 310. In operation 302A, US 310 transmits UEInformationResponse message including a RLF-report to BS 320. BS 320 can optimize a mobility problem based on the response transmitted from UE 310.

A successful handover report (SHR) has been introduced to enhance the MRO function in 3GPP 5G NR, to provide a more robust mobility via reporting failure events observed during successful handovers. UE may compile a SHR which is associated with a successful handover comprising a set of measurements collected during the handover phase, i.e., measurement at the handover trigger, measurement at the end of handover execution, or measurement after handover execution. The UE could be configured with trigger condition(s) to compile the SHR. Hence, the SHR would be triggered only if the trigger condition(s) is met.

The availability of a SHR may be indicated by the Handover Complete message (e.g., RRCReconfigurationComplete message) transmitted from a UE to target NG-RAN node over RRC signalling. The target NG-RAN node may fetch information of a SHR via “UE Information Request mechanism” or “UE Information Response mechanism”. In addition, the target NG-RAN node could then forward the SHR included in ACCESS AND MOBILITY INDICATION message shown in FIG. 5 to the source NR-RAN node via Xn interface, to indicate failure(s) experienced during a successful handover event.

Upon reception of a SHR, the receiving node is able to analyse whether its mobility configuration needs adjustment. Such adjustments may result in changes of mobility configurations, such as, changes of RLM configurations or changes of mobility thresholds between the source and the target. In addition, target NG-RAN node, in the performed handover, may further optimize the dedicated RACH-beam resources based on the beam measurements reported upon successful handovers.

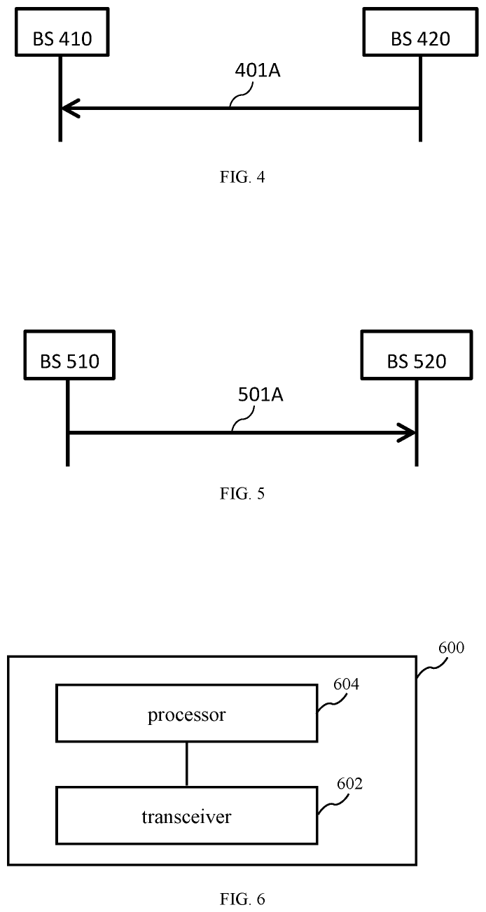

In a 3GPP 5G system, a failure indication procedure may be initiated after a UE attempts to re-establish the radio link connection at NG-RAN node B (e.g., BS 420 in FIG. 4) after a failure at NG-RAN node A (e.g., BS 410 in FIG. 4). NG-RAN node B (e.g., BS 420 in FIG. 4) may initiate a failure indication procedure towards multiple NG-RAN nodes if they control cells which use a physical cell identifier (PCI) signaled by the UE during the RRC re-establishment procedure. A failure indication may also be sent to the node last serving the UE when the NG-RAN node fetches the RLF-report from the UE. A specific example of a failure indication procedure is described in FIG. 4.

The purpose of the failure indication procedure is to transfer information regarding RRC re-establishment attempts, or received RLF-reports, between NG-RAN nodes. The signaling takes place from the NG-RAN node at which a re-establishment attempt is made, or a RLF-report is received, to an NG-RAN node to which the UE concerned may have previously been attached prior to the connection failure. This may aid the detection of a RLF case or a HO failure case.

FIG. 4 illustrates an exemplary failure indication procedure in accordance with some embodiments of the present application. The embodiments of FIG. 4 show a procedure of one BS (e.g., BS 410) communicating with another BS (e.g., BS 420). In some examples, BS 410 may function as a MN (e.g., MN 302 in FIG. 8) or a source SN (e.g., S-SN 303 in FIG. 8), and BS 420 may function as a target SN (e.g., T-SN 304 in FIG. 8).

As shown in FIG. 4, in operation 401A, BS 420 transmits a failure indication message to BS 410. BS 410 is a source BS which controls the original serving cell of a UE (e.g., UE 101 as illustrated and shown in FIG. 1). BS 420 is a target BS or a new BS which controls a target cell or a conditional handover (CHO) candidate cell of the UE. The failure indication message may be transmitted by Xn interface or X2 interface. For example, the failure indication message includes a container of a RLF-report. The container of the RLF-report may be transmitted by Xn interface or X2 interface.

In a 3GPP 5G system, an access and mobility indication procedure may be initiated after a successful random access operation of NG-RAN nodes. The purpose of the access and mobility indication procedure is to transfer access and mobility related information between NG-RAN nodes via Xn interface. A specific example of a failure indication procedure is described in FIG. 5.

FIG. 5 illustrates an exemplary access and mobility indication procedure in accordance with some embodiments of the present application. The embodiments of FIG. 5 show a procedure of one BS (e.g., BS 510) communicating with another BS (e.g., BS 520). In some examples, BS 510 may function as a target SN (e.g., T-SN 304 in FIG. 8), and BS 520 may function as a MN (e.g., MN 302 in FIG. 8) or a source SN (e.g., S-SN 303 in FIG. 8).

As shown in FIG. 5, in operation 501A, BS 510 transmits an access and mobility indication message to BS 520. BS 510 initiates the access and mobility indication procedure by sending the access and mobility indication message to BS 520. The access and mobility indication message may be transmitted by Xn interface or X2 interface. For example, the access and mobility indication message includes a container of a RA-report list from a UE. RA-Report List is defined in 3GPP TS38.331. The container of the RA-report may be transmitted by Xn interface or X2 interface.

Currently, there is no MRO mechanism for a successful PSCell addition procedure, a conditional PSCell addition (CPA) procedure, a conditional PSCell change (CPC) procedure, and/or a successful PSCell change procedure after a SCG failure information procedure. For instance, following issues need to be addressed.

According to agreements in 3GPP RAN2#113b meeting based on the contribution that upon initiating a SCG failure information procedure, if timer T310 or timer T312 for the PSCell expires before the SCG link is recovered, a UE does not trigger another SCG failure information procedure. Therefore, the UE will not stop timer T310 and timer T312 upon initiating the SCG failure information procedure. It makes sense that whether timer T310 and/or timer T312 is running can be reported to a MCG in a SCG failure information message for a self-optimisation (SON) purpose.

Thus, an issue which needs to be addressed is how to include enhanced failure information in a SCG failure information message for a SCG failure case.

In addition, in a case that a UE transmits a SPAR or a SPCR, several issues should be addressed: (1) which network node configures (e.g., a MN, a source SN, or a target SN) trigger condition(s) for a SPAR or a SPCR; (2) which network node (e.g., a target SN or a MN) should a UE reports to; and (3) whether should a SPCR be transferred to a source SN for a SN initiated CPC procedure and a MN initiated CPC procedure.

In legacy SHR, at least one of timers T310, T312 and T304 is configured for triggering a SHR. Similarly, timers T310, T312 and T304 also can be considered as the trigger condition to report a SPCR. One use case is that if the trigger condition associated with timer T310 or timer T312 is included in a PSCell change command during a SCG failure information procedure, timer T310 or timer T312 could expire already when a UE receives the PSCell change command. Thus, an issue which needs to be addressed is how to design a MRO mechanism for a successful PSCell change procedure after receiving a PSCell change command during a SCG failure information procedure.

Embodiments of the present application aim to address the above-mentioned issues. Specifically, some embodiments of the present application study enhanced failure information included in a SCG failure information message for a SCG failure case. In some embodiments of the present application, when a SCG failure information procedure is triggered and timer T310 or timer T312 is running, a UE will not stop timer T310 or timer T312.

Some embodiments of the present application introduce a trigger condition for a SPAR or a SPCR, which cover following cases: a PSCell addition procedure, a CPA procedure; a MN initiated CPC procedure; a SN initiated CPC procedure; and a successful PSCell change procedure after a SCG failure information procedure. A CPA procedure may be deemed as a special example of a normal PSCell addition procedure without condition, and thus these two procedures may use the same or similar message to report related information. More details will be illustrated in following text in combination with the appended drawings.

FIG. 6 illustrates an exemplary block diagram of an apparatus according to some embodiments of the present application. As shown in FIG. 6, the apparatus 600 may include at least one processor 604 and at least one transceiver 602 coupled to the processor 604. The at least one transceiver 602 may be a wired transceiver or a wireless transceiver. The apparatus 600 may be a UE or a network node (e.g., a MN, a source SN, or a target SN).

Although in this figure, elements such as the at least one transceiver 602 and the processor 604 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 500 may further include an input device, a memory, and/or other components.

In some embodiments of the present application, the apparatus 600 may be a UE (e.g., UE 101, UE 210, UE 201, UE 301, or UE 401 as shown and illustrated in any of FIGS. 1, 2, and 7-9). The processor 604 of the UE may be configured: to receive, via the transceiver 602 from a MN (e.g., MN 102 as shown and illustrated in FIG. 1), configuration information regarding a PSCell addition or change procedure, wherein the configuration information includes a trigger condition to transmit assistant information, and wherein the assistant information is related to successfully completing the PSCell addition or change procedure; and to transmit the assistant information via the transceiver 602 to at least one of the MN, a source SN, or a target SN, in response to successfully completing the PSCell addition or change procedure and in response to meeting the trigger condition to transmit assistant information. In some embodiments, the assistant information includes at least one of a SHR, a SPAR, or a SPCR.

According to some embodiments, the PSCell addition or change procedure includes at least one of: a PSCell addition procedure; a CPA procedure; a PSCell change procedure; a MN initiated CPC procedure; or a SN initiated CPC procedure. The processor 604 of the UE applies configuration information of the PSCell addition procedure upon reception of the configuration information of the PSCell addition procedure. The processor 604 of the UE applies configuration information of the PSCell change procedure upon reception of the configuration information of the PSCell change procedure.

In some embodiments, in response to the configuration information regarding at least one of the PSCell addition procedure, the CPA procedure, or the MN initiated CPC procedure:
(1) a 1st threshold associated with a handover timer (e.g., timer T304) for the trigger condition is configured by the target SN; or
(2) a 2nd threshold associated with a physical layer problem timer (e.g., timer T310) for the trigger condition is configured by the MN; or
(3) a 3rd threshold associated with “a timer for initiating failure recovery based on triggering measurement report” (e.g., timer T312) for the trigger condition is configured by the MN. In some embodiments, at least one of the abovementioned thresholds is a percent value of a timer length.

In some further embodiments, in response to the configuration information regarding the SN initiated CPC procedure:
(1) a 4th threshold associated with “a physical layer problem timer” (e.g., timer T310) for the trigger condition is configured by the source SN; or
(2) a 5th threshold associated with “a timer for initiating failure recovery based on triggering measurement report” (e.g., timer T312) for the trigger condition is configured by the source SN; or
(3) a 6th threshold associated with a handover timer (e.g., timer T304) for the trigger condition is configured by the target SN; or
(4) a 7th threshold associated with the physical layer problem timer (e.g., timer T310) for the trigger condition is configured by the MN; or
(5) a 8th threshold associated with “the timer for initiating failure recovery” (e.g., timer T312) for the trigger condition is configured by the MN.

In some embodiments, at least one of the abovementioned 1st to 8th thresholds is a percent value of a timer length, e.g., 60%.

In some embodiments, the trigger condition to transmit assistant information includes at least one of:
(1) An elapsed time duration of the handover timer (e.g., timer T304) exceeds the 1st threshold (e.g., 60%) multiplied by a length of the handover timer (e.g., it is configured as 400 ms). For example, if the elapsed time duration of timer T304 is 300 ms, since 60%*400 ms=240 ms, and 300 ms is greater than 240 ms, the trigger condition to transmit assistant information is considered as met.
(2) An elapsed time duration of the physical layer problem timer (e.g., timer T310) exceeds the 2nd threshold (e.g., 40%) multiplied by a length of the physical layer problem timer (e.g., it is configured as 600 ms).
(3) An elapsed time duration of the timer for initiating failure recovery (e.g., timer T312) exceeds the 3rd threshold (e.g., 20%) multiplied by a length of the timer for initiating failure recovery (e.g., it is configured as 600 ms).
(4) The elapsed time duration of the physical layer problem timer (e.g., timer T310) exceeds the 4th threshold (e.g., 40%) multiplied by the length of the physical layer problem timer (e.g., it is configured as 500 ms).
(5) The elapsed time duration of the timer for initiating failure recovery (e.g., timer T312) exceeds the 5th threshold (e.g., 40%) multiplied by the length of the timer for initiating failure recovery (e.g., it is configured as 400 ms).
(6) The elapsed time duration of the handover timer (e.g., timer T304) exceeds the 6th threshold (e.g., 40%) multiplied by the length of the handover timer (e.g., it is configured as 300 ms).
(7) The elapsed time duration of the physical layer problem timer (e.g., timer T310) exceeds the 7th threshold (e.g., 20%) multiplied by the length of the physical layer problem timer (e.g., it is configured as 600 ms).
(8) The elapsed time duration of the timer for initiating failure recovery (e.g., timer T312) exceeds the 8th threshold (e.g., 60%) multiplied by the length of the timer for initiating failure recovery (e.g., it is configured as 600 ms).
(9) An expiry of the handover timer (e.g., timer T304). For example, upon the expiry of timer T304, the trigger condition to transmit assistant information is considered as met.
(10) An expiry of the physical layer problem timer (e.g., timer T310). For example, upon the expiry of timer T310, the trigger condition to transmit assistant information is considered as met.
(11) An expiry of the timer for initiating failure recovery (e.g., timer T312). For example, upon the expiry of timer T312, the trigger condition to transmit assistant information is considered as met.
(12) The elapsed time duration of the physical layer problem timer (e.g., timer T310) after initiating a SCG failure information procedure exceeds another threshold (e.g., 60%) multiplied by the length of the physical layer problem timer (e.g., it is configured as 500 ms).

In some embodiments, in response to “the configuration information including the trigger condition to transmit the assistant information” configured by the source SN, the configuration information including the trigger condition is received by the MN from the source SN via a SN change required message. In some other embodiments, in response to “the configuration information including the trigger condition to transmit the assistant information” configured by the target SN, the configuration information including the trigger condition is received by the MN from the target SN via a SN addition request acknowledge message.

In some embodiments, the processor 604 of the UE is configured to transmit, via the transceiver 602 to the MN, information indicating which trigger condition having been met in response to meeting at least one trigger condition in the configuration information. In an embodiment, the information is carried in a RRC reconfiguration complete message. In an embodiment, the information includes at least one of:
(1) information indicating that a trigger condition related to a physical layer problem timer (e.g., timer T310) has been met for a SPAR or a SPCR, in response to meeting the trigger condition related to the physical layer problem timer (e.g., timer T310); or
(2) information indicating that a trigger condition related to “a timer for initiating failure recovery based on triggering measurement report” (e.g., timer T312) has been met for the SPAR or the SPCR, in response to meeting the trigger condition related to “the timer for initiating failure recovery” (e.g., timer T312).

In some embodiments, the processor 604 of the UE is configured to receive a request via the transceiver 602 from the MN. The request includes information indicating that a SPAR or a SPCR should be reported. In some embodiments, the request is carried in a UE information request message. In some embodiments, the assistant information is transmitted in a response to the MN, and the assistant information includes the SPAR or the SPCR. In some embodiments, the response is carried in a UE information response message.

In some embodiments, the processor 604 of the UE is configured to transmit, via the transceiver 602 to the target SN, information indicating that a SPAR or a SPCR is available. In some embodiments, the processor 604 of the UE is configured to receive a request for the SPAR or the SPCR via the transceiver 602 from the target SN; and to transmit the SPAR or the SPCR via the transceiver 602 to the target SN, in response to receiving the request from the target SN.

In some embodiments of the present application, the apparatus 600 may be a MN (e.g., MN 102, MN 220, BS 320, MN 202, MN 302, or MN 402 as shown and illustrated in any of FIGS. 1-3 and 7-9). The processor 604 of the MN may be configured: to transmit, via the transceiver 602 to a UE (e.g., UE 101 as shown and illustrated in FIG. 1), configuration information regarding a PSCell addition or change procedure, wherein the configuration information includes a trigger condition to transmit assistant information, and wherein the assistant information is related to successfully completing the PSCell addition or change procedure; and to receive the assistant information via the transceiver 602 from the UE, in response to successfully completing the PSCell addition or change procedure and in response to meeting the trigger condition. In some embodiments, the assistant information includes at least one of a SHR, a SPAR, or a SPCR.

In some embodiments, the processor 604 of the MN is configured to receive the configuration information including the trigger condition via the transceiver 602 from a source SN or a target SN, before transmitting the configuration information.

In an embodiment, in response to the configuration information configured by the source SN, the configuration information is received by the MN from the source SN via a SN change required message. In an embodiment, in response to the configuration information configured by the target SN, the configuration information is received by the MN from the target SN via a SN addition request acknowledge message.

According to some embodiments, the PSCell addition or change procedure includes at least one of: a PSCell addition procedure; a CPA procedure; a PSCell change procedure; a MN initiated CPC procedure; or a SN initiated CPC procedure.

The UE applies configuration information of the PSCell addition procedure upon reception of the configuration information of the PSCell addition procedure. The UE applies configuration information of the PSCell change procedure upon reception of the configuration information of the PSCell change procedure.

According to some embodiments, in response to the configuration information regarding at least one of the PSCell addition procedure, the CPA procedure, or the MN initiated CPC procedure:
(1) a 1st threshold associated with a handover timer (e.g., timer T304) for the trigger condition is configured by a target SN; or
(2) a 2nd threshold associated with a physical layer problem timer (e.g., timer T310) for the trigger condition is configured by the MN; or
(3) a 3rd threshold associated with “a timer for initiating failure recovery based on triggering measurement report” (e.g., timer T312) for the trigger condition is configured by the MN.

In some further embodiments, in response to the configuration information regarding the SN initiated CPC procedure:
(1) a 4th threshold associated with a physical layer problem timer (e.g., timer T310) for the trigger condition is configured by the source SN; or
(2) a 5th threshold associated with a timer for initiating failure recovery based on triggering measurement report (e.g., timer T312) for the trigger condition is configured by the source SN; or
(3) a 6th threshold associated with a handover timer (e.g., timer T304) for the trigger condition is configured by the target SN; or
(4) a 7th threshold associated with the physical layer problem timer (e.g., timer T310) for the trigger condition is configured by the MN; or
(5) a 8th threshold associated with the timer for initiating failure recovery (e.g., timer T312) for the trigger condition is configured by the MN.

In some embodiments, at least one of the abovementioned 1st to 8th thresholds is a percent value of a timer length, e.g., 60%.

In some embodiments, the trigger condition to transmit assistant information includes at least one of:
(1) an elapsed time duration of the handover timer (e.g., timer T304) exceeds the 1st threshold multiplied by a length of the handover timer;
(2) an elapsed time duration of the physical layer problem timer (e.g., timer T310) exceeds the 2nd threshold multiplied by a length of the physical layer problem timer; (3) an elapsed time duration of the timer for initiating failure recovery (e.g., timer T312) exceeds the 3rd threshold multiplied by a length of the timer for initiating failure recovery;
(4) the elapsed time duration of the physical layer problem timer (e.g., timer T310) exceeds the 4th threshold multiplied by the length of the physical layer problem timer; (5) the elapsed time duration of the timer for initiating failure recovery (e.g., timer T312) exceeds the 5th threshold multiplied by the length of the timer for initiating failure recovery;
(6) the elapsed time duration of the handover timer (e.g., timer T304) exceeds the 6th threshold multiplied by the length of the handover timer;
(7) the elapsed time duration of the physical layer problem timer (e.g., timer T310) exceeds the 7th threshold multiplied by the length of the physical layer problem timer; (8) the elapsed time duration of the timer for initiating failure recovery (e.g., timer T312) exceeds the 8th threshold multiplied by the length of the timer for initiating failure recovery;
(9) an expiry of the handover timer (e.g., timer T304); (10) an expiry of the physical layer problem timer (e.g., timer T310);
(11) an expiry of the timer for initiating failure recovery (e.g., timer T312); or
(12) the elapsed time duration of the physical layer problem timer (e.g., timer T310) after initiating a SCG failure information procedure exceeds a 9th threshold multiplied by the length of the physical layer problem timer.

According to some embodiments, the processor 604 of the MN is configured to receive, via the transceiver 602 from the UE, information indicating which trigger condition having been met in response to meeting at least one trigger condition in the configuration information. In some embodiments, wherein the information includes at least one of:
(1) information indicating that a trigger condition related to “a physical layer problem timer” (e.g., timer T310) has been met for a SPAR or a SPCR, in response to meeting the trigger condition related to “the physical layer problem timer”; or
(2) information indicating that a trigger condition related to “a timer for initiating failure recovery based on triggering measurement report” (e.g., timer T312) has been met for the SPAR or the SPCR, in response to meeting the trigger condition related to “the timer for initiating failure recovery” (e.g., timer T312).

In some embodiments, the processor 604 of the MN is configured to transfer the first information to a SN (e.g., SN 103 as shown and illustrated in FIG. 1) during a SN initiated PSCell change procedure or a SN initiated CPC procedure.

In some embodiments, the processor 604 of the MN is configured to transmit a request via the transceiver 602 to the UE. The request includes information indicating that a SPAR or a SPCR should be reported. The request may be carried in a UE information request message. In some embodiments, the assistant information is received in a response from the UE, and the assistant information includes the SPAR or the SPCR. The response may be carried in a UE information response message.

According to some embodiments, the processor 604 of the MN is configured to receive, via the transceiver 602 from a source SN, a request indicating that a SPAR or a SPCR should be reported; and to transfer the request to the UE. In some embodiments, the assistant information is received from the UE during “a SN initiated PSCell change procedure” or “a SN initiated CPC procedure”, wherein the assistant information includes the SPAR or the SPCR. The processor 604 of the MN may be further configured to transfer the assistant information via the transceiver 602 to the source SN.

In some embodiments of the present application, the apparatus 600 may be a source SN (e.g., SN 103, BS 410, BS 520, S-SN 303, or S-SN 403 as shown and illustrated in any of FIGS. 1, 4, 5, 8, and 9). The processor 604 of the source SN may be configured: to generate configuration information regarding a PSCell change procedure, wherein the configuration information includes a trigger condition to transmit assistant information, and wherein the assistant information is related to successfully completing the PSCell change procedure; and to transmit the configuration information via the transceiver 602 to a UE (e.g., UE 101 as shown and illustrated in FIG. 1) via a MN (e.g., MN 102 as shown and illustrated in FIG. 1). In some embodiments, the assistant information includes at least one of a SHR, a SPAR, or a SPCR.

In some embodiments, the PSCell change procedure includes at least one of: a PSCell change procedure; or a SN initiated CPC procedure.

According to some embodiments, a threshold associated with a physical layer problem timer (e.g., timer T310) for the trigger condition is configured by the source SN. A further threshold associated with “a timer for initiating failure recovery based on triggering measurement report” (e.g., timer T312) for the trigger condition is configured by the source SN. The threshold and/or the further threshold may be a percent value of a timer length, e.g., 40%.

In some embodiments, the trigger condition to transmit assistant information includes at least one of:
(1) an elapsed time duration of the physical layer problem timer (e.g., timer T310) exceeds the threshold multiplied by a length of the physical layer problem timer;
(2) an elapsed time duration of the timer for initiating failure recovery (e.g., timer T312) exceeds the further threshold multiplied by a length of the timer for initiating failure recovery;
(3) an expiry of the physical layer problem timer (e.g., timer T310);
(4) an expiry of the timer for initiating failure recovery (e.g., timer T312); or
(5) the elapsed time duration of the physical layer problem timer (e.g., timer T310) after initiating a SCG failure information procedure exceeds another threshold multiplied by the length of the physical layer problem timer.

In some embodiments, the processor 604 of the source SN is configured to receive the assistant information via the transceiver 602, in response to successfully completing the PSCell change procedure and in response to meeting the trigger condition. In some embodiments, the configuration information including the trigger condition is transmitted to a UE, and the assistant information is received from the UE. In some other embodiments, the configuration information including the trigger condition is transmitted to the MN, and the assistant information is received from the MN. In response to the configuration information transmitted to the MN, the configuration information may be carried in a SN change required message.

According to some embodiments, the processor 604 of the source SN is configured to receive information via the transceiver 602 from the MN. The information indicates that a trigger condition related to a SPCR has been met. In some embodiments, the processor 604 of the source SN is configured to transmit a request to the MN. The request includes information indicating that the SPCR should be reported. The request may be carried in a UE information request message. In some embodiments, the assistant information is received in a response from the MN, and the assistant information includes the SPCR. The response may be carried in a UE information response message.

In some embodiments of the present application, the apparatus 600 may be a target SN (e.g., SN 103, BS 420, BS 510, T-SN 304, or T-SN 404 as shown and illustrated in any of FIGS. 1, 4, 5, 8, and 9). The processor 604 of the target SN may be configured to generate configuration information regarding a primary cell of a second cell group (PSCell) addition or change procedure. The configuration information includes a trigger condition to transmit assistant information, and wherein the assistant information is related to successfully completing the PSCell addition or change procedure. The processor 604 of the target SN may be further configured to transmit the configuration information via the transceiver 602 to at least one of a UE (e.g., UE 101 as shown and illustrated in FIG. 1) or a MN (e.g., MN 102 as shown and illustrated in FIG. 1). According to some embodiments, the configuration information is carried in a SN addition request acknowledge message. In some embodiments, the assistant information includes at least one of a SHR, a SPAR, or a SPCR.

According to some embodiments, the PSCell addition or change procedure includes at least one of: a PSCell addition procedure; a CPA procedure; a PSCell change procedure; a MN initiated CPC procedure; or a SN initiated CPC procedure.

In some embodiments, the trigger condition is related to a threshold associated with a handover timer (e.g., timer T304). For example, the threshold is a percent value of a timer length (e.g., 60%). In some embodiments, the trigger condition to transmit assistant information includes at least one of: an elapsed time duration of the handover timer exceeds the threshold multiplied by the length of the handover timer; or an expiry of the handover timer.

According to some embodiments, the processor 604 of the target SN is configured to receive the assistant information via the transceiver 602 from the UE, in response to successfully completing the PSCell addition or change procedure and in response to meeting the trigger condition.

According to some embodiments, the processor 604 of the target SN is configured to receive, via the transceiver 602 from the UE, information indicating that a trigger condition related to a SPCR or a SPAR has been met. In some embodiments, the processor 604 of the target SN is configured to transmit a request to the UE. The request includes information indicating that the SPCR or the SPAR should be reported. The request may be carried in a UE information request message. In some embodiments, the assistant information is received in a response from the UE, and the assistant information includes the SPCR or the SPAR. The response may be carried in a UE information response message.

In some embodiments of the present application, the apparatus 600 may be a UE (e.g., UE 101, UE 210, UE 201, UE 301, or UE 401 as shown and illustrated in any of FIGS. 1, 2, and 7-9). The processor 604 of the UE may be configured: to initiate a SCG failure information procedure; and to transmit SCG failure information message, via the transceiver 602 to a MN, wherein the SCG failure information message includes at least one of “information which indicates whether a physical layer problem timer (e.g., timer T310) is running” or “information which indicates whether a timer for initiating failure recovery based on triggering measurement report (e.g., timer T312) is running”. Specific examples are described in Embodiment 1 for network slicing as follows.

According to some embodiments, the processor 604 of the UE is configured: to transmit, via the transceiver 602 to the MN, an elapsed time duration of the physical layer problem timer after initiating the SCG failure information procedure, in response to the physical layer problem timer running; or to transmit, via the transceiver 602 to the MN, an elapsed time duration of the timer for initiating failure recovery (e.g., timer T312) after initiating the SCG failure information procedure, in response to the timer for initiating failure recovery (e.g., timer T312) running.

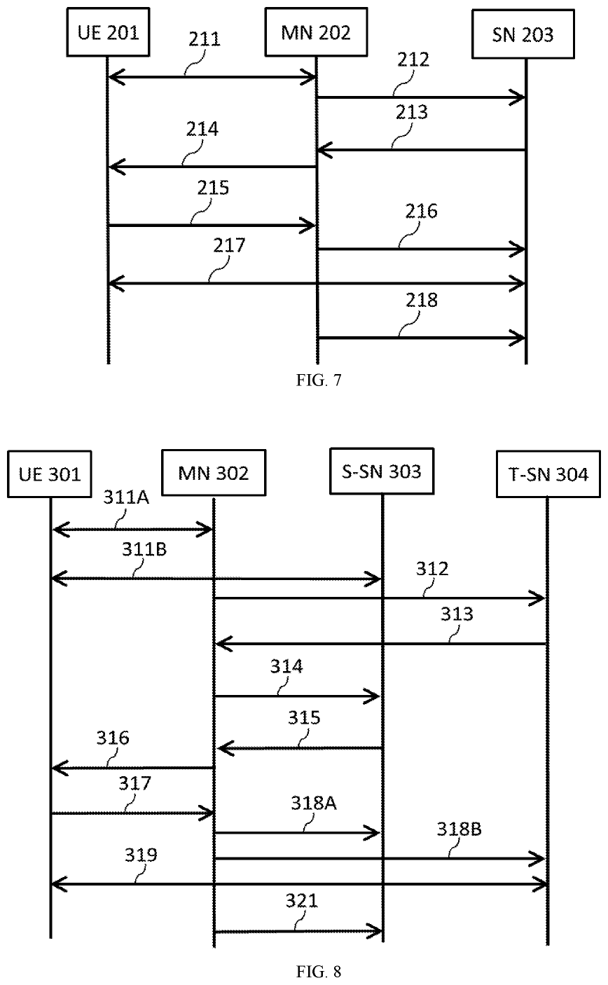

In some embodiments of the present application, the apparatus 600 may include at least one non-transitory computer-readable medium. In some embodiments of the present disclosure, the non-transitory computer-readable medium may have stored thereon computer-executable instructions to cause a processor to implement the method with respect to a UE or a network node (e.g., MN, source SN or target SN) as described above. For example, the computer-executable instructions, when executed, cause the processor 604 interacting with the transceiver 602, so as to perform operations of the methods, e.g., as described in view of FIGS. 7-9.

The following texts describe specific Embodiments 1 and 2 of the embodiments as shown and illustrated in FIG. 6, in which a UE and a network node (e.g., a MN, a source SN, or a target SN) perform following operations.

### Embodiment 1

Embodiment 1 refers to a scenario that enhanced failure information is included in a SCGFailureinformation message for a SCG failure case. In particular, in Embodiment 1, following steps may be performed.
(1) Step 1: a UE (e.g., UE 101 as shown and illustrated in FIG. 1) accesses a network via dual connectivity (DC).
   A SN (e.g., SN 103 as shown and illustrated in FIG. 1) is configured to the UE.
(2) Step 2: The UE starts timer T310 on a SCG
   In an embodiment, the UE may start timer T312 on the SCG
(3) Step 3: The UE initiates a SCG failure information procedure to report SCG failure(s) when at least one of following conditions is met:
   upon detecting a RLF for the SCG;
   upon a reconfiguration with sync failure of the SCG;
   upon a SCG configuration failure; or
   upon an integrity check failure indication from SCG lower layer(s) concerning SRB3.
(4) Step 4: The UE transmits SCGFailureInformation message. Any or a combination of following information could be included in the SCGFailureInformation message:
   1) FailureType and measurement result(s).
   2) Information regarding whether timer T310 is running can be reported to a MCG in the SCGFailureInformation message.
      In an embodiment, the elapsed time duration of timer T310 upon initiating the SCG failure information procedure can be reported if timer T310 is running.
   3) Information regarding whether timer T312 is running can be reported to the MCG in the SCGFailureInformation message.
      In an embodiment, the elapsed time duration of timer T312 upon initiating the SCG failure information procedure can be reported if timer T312 is running.
(5) Step 5: After a MN (e.g., MN 102 as shown and illustrated in FIG. 1) receives the SCGFailureInformation message, the MN may transmit a PSCell change command, e.g., in RRCReconfiguration message, to the UE.
(6) Step 6: The UE receives the RRCReconfiguration message including the PSCell change command. The UE performs a PSCell change procedure.

### Embodiment 2

Embodiment 2 refers to a MRO mechanism for a successful PSCell change procedure after receiving a PSCell change command during a SCG failure information procedure. In particular, in Embodiment 2, following steps may be performed.
(1) Step 1: A UE (e.g., UE 301 as shown and illustrated in FIG. 8) accesses a network via DC.
   A SN (e.g., S-SN 303 as shown and illustrated in FIG. 8) is configured to the UE.
(2) Step 2: The UE starts timer T310 on a SCG
   In an embodiment, the UE may start timer T312 on the SCG
(3) Step 3: The UE initiates a SCG failure information procedure to report SCG failure(s) when at least one of following conditions is met:
   upon detecting a RLF for the SCG;
   upon a reconfiguration with sync failure of the SCG;
   upon a SCG configuration failure; or
   upon an integrity check failure indication from SCG lower layer(s) concerning SRB3.
(4) Step 4: The UE transmits SCGFailureInformation message. Any or a combination of following information could be included in the SCGFailureInformation message.
1) FailureType and measurement result(s).
2) Information regarding whether timer T310 is running can be reported to a MCG in the SCGFailureInformation message.
In an embodiment, the elapsed time duration of timer T310 upon initiating the SCG failure information procedure can be reported if timer T310 is running.
3) Information regarding whether timer T312 is running can be reported to the MCG in the SCGFailureInformation message.
In an embodiment, the elapsed time duration of timer T312 upon initiating the SCG failure information procedure can be reported if timer T312 is running.
(5) Step 5: After a MN (e.g., MN 302 as shown and illustrated in FIG. 8) receives the SCGFailureInformation message, the MN may transmit a PSCell change command to the UE. In some embodiments, a trigger condition to report a SPCR is as follows:
   Option 1: a trigger condition associated with timer T310 could be “whether the elapsed time duration of timer T310 exceeds a configured threshold”.
      In an embodiment, the configured threshold may be configured as a time value which is less than a time length of timer T310. An expiry of timer T310 can be considered as that the trigger condition associated with timer T310 has been met. Once timer T310 expires, the elapsed time duration of timer T310 exceeds the configured threshold (which is less than the time length of timer T310), and thus the trigger condition is met.
   Option 2: an expiry of timer T310 may be configured as a trigger condition associated with timer T310; and/or an expiry of timer T312 may be configured as a trigger condition associated with timer T312.
   Option 3: The elapsed time duration of timer T310 after initiating the SCG failure information procedure exceeds a configured threshold. Namely, whether the elapsed time duration of timer T310 exceeds the configured threshold depends on the time that a SCG failure happens.
      In an embodiment, when a SCG failure happens, a SCG failure information procedure is initiated, and the elapsed time duration of timer T310 is computed since the time of initiating the SCG failure information procedure, instead of the starting time of timer T310. If the computed elapsed time duration of timer T310 exceeds the configured threshold, the trigger condition is met.
   The above threshold(s) for trigger condition(s) associated with timer T310 and/or timer T312 may be configured by a MN.
   The trigger condition associated with timer T304 can be configured to the UE. A threshold for the trigger condition associated with timer T304 may be configured by a target SN.
(6) Step 6: The UE receives RRCReconfiguration message including a PSCell change command. The UE performs a PSCell change procedure.
(7) Step 7: The UE will log the information associated with a SPCR if a trigger condition to report the SPCR is met.
(8) Step 8: The UE transmits a RRC message to a target SN (e.g., T-SN 304 as shown and illustrated in FIG. 8). The RRC message includes an indication which indicates that the SPCR is available.
(9) Step 9: The target SN transmits UEInformationRequest message to the UE after receiving the indication from the UE.
   The UEInformationRequest message may include an indication which indicates that the SPCR should be reported.
(10) Step 10: The UE transmits UEInformationResponse message to the target SN.
   The UEInformationResponse message includes the SPCR.
(11) Step 11: After the target SN receives the report message from the UE, the target SN transmits the SPCR to the MN.
   The SPCR could be included in Xn interface message (e.g., a failure indication message or a new Xn interface message) to the MN.
   The report message reported by the UE may be transmitted as a container.
   The Xn interface message to the MN includes the indication which indicates that the SPCR is available.

FIG. 7 illustrates a further exemplary flow chart of a report for PSCell addition and conditional PSCell addition procedures according to some embodiments of the present application.

The embodiments of FIG. 7 aim to address issues in a case that a UE transmits a SPAR or a SPCR: (1) which network node configures (e.g., a MN, a source SN, or a target SN) trigger condition(s) for a SPAR or a SPCR; (2) which network node (e.g., a target SN or a MN) should a UE reports to; and (3) whether should a SPCR be transferred to a source SN for a SN initiated CPC procedure and a MN initiated CPC procedure. In particular, following steps may be performed in the embodiments of FIG. 7.

In operation 211 as shown in FIG. 7, UE 201 accesses a network node, i.e., MN 202, via non-DC in which no SN is configured to UE 201.

In operation 212 as shown in FIG. 7, MN 202 decides to add one SN for UE 201 and transmits SgNB Addition Request message or S-NODE ADDITION REQUEST message to SN 203 (which may also be named as target SN 203 in some cases).

In operation 213 as shown in FIG. 7, SN 203 transmits SgNB Addition Request Acknowledge message or S-NODE ADDITION REQUEST ACKNOWLEDGE message to MN 202, if SN 203 is able to admit the resource request. SN 203 will allocate respective radio resource(s).
(1) For a CPA case, the execution condition to trigger a CPA procedure will be included in the message transmitted in operation 213.
(2) A threshold for a trigger condition, e.g., associated with timer T304, may be included in the message transmitted in operation 213. The threshold may be a percent, e.g., 60%. The trigger condition could be that the elapsed time duration of a timer (e.g., T304) is greater than a threshold. For example, if the elapsed time duration of timer T304 (e.g., 500 ms) is greater than “60%*a configured length of timer T304”, a report procedure (e.g., a SHR, a SPAR, or a SPCR) will be triggered. That is, a trigger condition for the report procedure will be met. If the configured length of timer T304 is 600 ms, “60%*600 ms” is 360 ms. Since the elapsed time duration of timer T304, i.e., 500 ms, is greater than 360 ms, the report will be triggered.

In operation 214 as shown in FIG. 7, MN 202 sends RRCReconfiguration message, which includes RRCConfiguration message from SN 203, to UE 201. The threshold for a trigger condition, e.g., associated with timer T310 or T312 on SN 203, may be added in the RRCReconfiguration message. The threshold may be a percent, e.g., 60%.

In operation 215 as shown in FIG. 7, UE 201 applies the new configuration and replies to MN 202 with RRCReconfigurationComplete message, including a RRC response message, if needed.
(1) For a CPA case, the execution condition to trigger a CPA procedure will be included in the message transmitted in operation 215. The RRCReconfigurationComplete message is transmitted when the execution condition to perform the CPA procedure is met.

In operation 216 as shown in FIG. 7, MN 202 informs SN 203 that UE 201 has successfully completed the RRC reconfiguration procedure via SgNB Reconfiguration Complete message, including the encoded a RRC response message, if it is received from UE 201.

In operation 217 as shown in FIG. 7, UE 201 performs random access to SN 203. After the successful random access, UE 201 will transmit an indication to indicate that the trigger condition for a SPAR, e.g., associated with timer T304, has been met.

In operation 218 as shown in FIG. 7, MN 202 transfers a message including the indication which is received from UE 201 to SN 203. In some embodiments, after receiving the message including the indication from MN 202, SN 203 may transmit UEInformationRequest message to UE 201. The UEInformationRequest message may include an indication to indicate that the SPAR should be reported.

Then, UE 201 may transmit UEInformationResponse message to SN 203. The UEInformationResponse message includes the SPAR.

Details described in all other embodiments of the present application (for example, details regarding a MRO mechanism for a SPAR or a SPCR and SCG failure information procedure) are applicable for the embodiments of FIG. 7.

Moreover, details described in the embodiments of FIG. 7 are applicable for all embodiments of FIGS. 1-6, 8, and 9. It should be appreciated by persons skilled in the art that the sequence of the operations in exemplary procedure in the embodiments of FIG. 7 may be changed and some of the operations in exemplary procedure in the embodiments of FIG. 7 may be eliminated or modified, without departing from the spirit and scope of the disclosure.

FIG. 8 illustrates a further exemplary flow chart of a MN initiated SN change procedure according to some embodiments of the present application. The embodiments of FIG. 8 refer to a MN initiated CPC procedure. The embodiments of FIG. 8 aim to address issues similar to those addressed by the embodiments of FIG. 7 in a case that a UE transmits a SPAR or a SPCR. In particular, following steps may be performed in the embodiments of FIG. 8.

In operations 311A and 311B as shown in FIG. 8, UE 301 accesses a network node, i.e., MN 302 and/or S-SN 303 (which is a source SN), via DC. MN 302 and S-SN 303 are configured to UE 301.

In operation 312 as shown in FIG. 8, after MN 302 decides to perform a PSCell change procedure based on measurement result(s) from UE 301, MN 302 sends SgNB Addition Request message or S-NODE ADDITION REQUEST message to T-SN 304 (which is a target SN).

In operation 313 as shown in FIG. 8, T-SN 304 transmits SgNB Addition Request Acknowledge message or S-NODE ADDITION REQUEST ACKNOWLEDGE message to MN 302, if T-SN 304 is able to admit the resource request. T-SN 304 will allocate respective radio resources.
(1) For a CPC case, the execution condition to trigger a CPC procedure will be included in the message transmitted in operation 313.
(2) The threshold for a trigger condition, e.g., associated with timer T304, may be added in the message transmitted in operation 313. The threshold may be a percent, e.g., 60% or 40%. The trigger condition could be that the elapsed time duration of a timer (e.g., T304) is greater than a threshold. For example, if the elapsed time duration of timer T304 (e.g., 600 ms) is greater than “40%*a configured length of timer T304”, a report procedure (e.g., a SHR, a SPAR, or a SPCR) will be triggered. If the configured length of timer T304 is 800 ms, “40%*800 ms” is 320 ms. Since 600 ms is greater than 320 ms, the report procedure will be triggered.

In operation 314 as shown in FIG. 8, if the resources allocation of T-SN 304 was successful, MN 302 initiates the resource release procedure of S-SN 303 via SgNB Release Request message. The SgNB Release Request message may include a cause indicating SCG mobility.

In operation 315 as shown in FIG. 8, S-SN 303 transmits SgNB Release Request Acknowledge message to MN 302.

In operation 316 as shown in FIG. 8, MN 302 sends to UE 301 the RRCReconfiguration message including a RRC configuration message from T-SN 304.

The threshold for a trigger condition, e.g., associated with timer T310 or timer T312, may be added in the message transmitted in operation 316. The threshold is a percent, e.g., 60%.

In operation 317 as shown in FIG. 8, UE 301 applies the new configuration and replies to MN 302 with RRCReconfigurationComplete message, including a RRC response message, if needed.
For a CPC case, whether the execution condition to trigger a CPC procedure is met or not will be included in the message transmitted in operation 317. If the trigger condition is met, more information, e.g., the satisfied condition, is also included in this message. The RRCReconfigurationComplete message is transmitted when the execution condition to perform the CPC procedure is met.
An indication to indicate which trigger condition is met if at least one trigger condition is met may be included in the message transmitted in operation 317. For example, if the trigger condition associated with timer T310 is met, the indication will be included to inform MN 302. In this case, MN 302 may transmit UEInformationRequest message to UE 301 after receiving the indication from UE 301. The UEInformationRequest message may include an indication to indicate that a SPCR should be reported. Then, UE 301 transmits UEInformationResponse to MN 302. The UEInformationResponse message includes the SPCR.
If the trigger condition to report the SPCR is met, UE 301 may log the information for the SPCR.

In operation 318A and 318B as shown in FIG. 8, MN 302 informs both S-SN 303 and T-SN 304 that UE 301 has successfully completed the reconfiguration procedure via SgNB Reconfiguration Complete message, including the encoded a RRC response message, if it is received from UE 301.

In operation 319 as shown in FIG. 8, UE 301 performs random access to T-SN 304. After the successful random access, UE 301 will transmit an indication to indicate that the trigger condition for a SPCR, e.g., associated with T304, has been met. In some cases, T-SN 304 may transmit UEInformationRequest message to UE 301 after receiving the indication from UE 301. The UEInformationRequest message may include an indication to indicate that the SPCR should be reported. Then, UE 301 may transmit UEInformationResponse message to T-SN 304. The UEInformationResponse message includes the SPCR.

In operation 321 as shown in FIG. 8, after completing data forwarding from S-SN 303, MN 302 transmits UEContextRelease message to S-SN 303.

Details described in all other embodiments of the present application (for example, details regarding a MRO mechanism for a SPAR or a SPCR and SCG failure information procedure) are applicable for the embodiments of FIG. 8. Moreover, details described in the embodiments of FIG. 8 are applicable for all embodiments of FIGS. 1-7 and 9. It should be appreciated by persons skilled in the art that the sequence of the operations in exemplary procedure in the embodiments of FIG. 8 may be changed and some of the operations in exemplary procedure in the embodiments of FIG. 8 may be eliminated or modified, without departing from the spirit and scope of the disclosure.

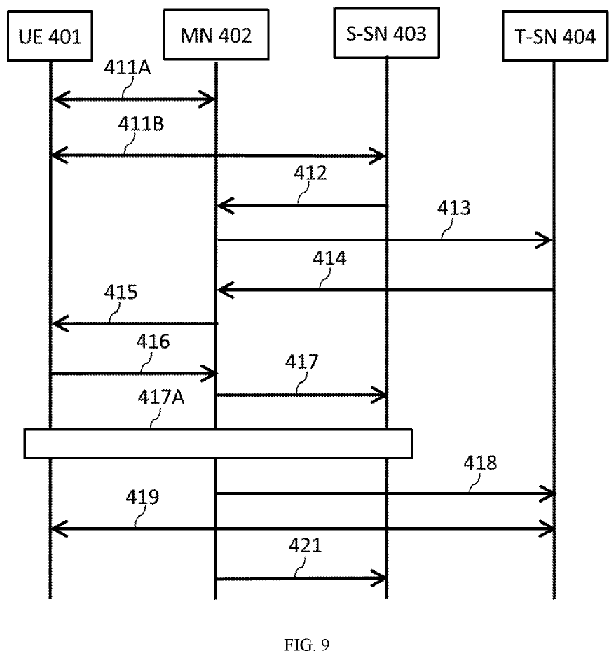

FIG. 9 illustrates a further exemplary flow chart of a SN initiated SN change procedure according to some embodiments of the present application. The embodiments of FIG. 9 refer to a SN initiated CPC procedure. The embodiments of FIG. 9 aim to address issues similar to those addressed by the embodiments of FIGS. 7 and 8 in a case that a UE transmits a SPAR or a SPCR. In particular, following steps may be performed in the embodiments of FIG. 9.

In operations 411A and 411B as shown in FIG. 9, UE 401 accesses network via DC. MN 402 and S-SN 403 (which is source SN) are configured to UE 401. In operation 412 as shown in FIG. 9, S-SN 403 initiates a SN change procedure by sending SgNB Change Required message to MN 402.
(1) For a CPC case, the execution condition to trigger a CPC procedure per a target cell will be included in the message transmitted in operation 412.
(2) The threshold for a trigger condition, e.g., associated with timer T310 or timer T312, may be added in the message transmitted in operation 412. The threshold is a percent, e.g., 60%. If multiple candidate cells are included, the threshold will be per candidate cell.

In operation 413 as shown in FIG. 9, after MN 402 receives the request from S-SN 403, MN 402 sends SgNB Addition Request message to T-SN 404.

In operation 414 as shown in FIG. 9, T-SN 404 transmits SgNB Addition Request Acknowledge message to MN 402 if T-SN 404 is able to admit the resource request. T-SN 404 will allocate respective radio resources.
(1) For a CPC case, the execution condition to trigger a CPC procedure will be included in the message transmitted in operation 414.
(2) The threshold for a trigger condition, e.g., associated with timer T304, may be included in the message transmitted in operation 414. The threshold is a percent, e.g., 60%. If the elapsed time period of timer T304 is greater than “60%*a configured length of timer T304” (e.g., 500 ms), a report procedure (e.g., a SHR, a SPAR, or a SPCR) will be triggered.

In operation 415 as shown in FIG. 9, MN 402 sends to UE 401 RRCReconfiguration message including a RRC configuration message from T-SN 404. The threshold for a trigger condition, e.g., associated with timer T310 or timer T312, may be added in the RRCReconfiguration message. The threshold is a percent of a timer length, e.g., 60%.

In operation 416 as shown in FIG. 9, UE 401 applies the new configuration and replies to MN 402 with RRCConnectionReconfigurationComplete message, including RRCResponse message, if needed.
(1) For a CPC case, the execution condition to trigger a CPC procedure will be included in the message transmitted in operation 416. The RRCConnectionReconfigurationComplete message is transmitted when the execution condition to perform the CPC procedure is met.
(2) An indication to indicate which trigger condition is met if at least one trigger condition is met may be added in the message transmitted in operation 416. For example, if the trigger condition associated with timer T310 is met, the indication will be included to inform MN 402.
(3) In a case that MN 402 configures a trigger condition, MN 402 transmits UEInformationRequest message to UE 401 after receiving the indication from UE 401. The UEInformationRequest message may include an indication to indicate that a SPCR should be reported. Then, UE 401 may transmit UEInformationResponse message to MN 402. The UEInformationResponse message includes the SPCR.
(4) In a case that S-SN 403 configures a trigger condition, MN 402 transmits the indication from UE 401 to S-SN 403. After receiving the indication from UE 401, S-SN 403 may transmit UEInformationRequest message to UE 401 via MN 402. The UEInformationRequest message may include an indication to indicate that a SPCR should be reported. Then, UE 401 may transmit UEInformationResponse message to S-SN 403 via MN 402. The UEInformationResponse message includes the SPCR.
(5) If the trigger condition to report the SPCR is met, UE 401 may log the information for the SPCR.

In operation 417 as shown in FIG. 9, MN 402 transmits SgNB Change Confirm message to S-SN 403.
(1) In the case that S-SN 403 configures a trigger condition, MN 402 transmits the indication from UE 401 (i.e., operation 416) to S-SN 403. After receiving the indication from UE 401, S-SN 403 transmits UEInformationRequest message to UE 401 via MN 402. The UEInformationRequest message may include an indication to indicate that a SPCR should be reported. Then, UE 401 may transmit UEInformationResponse message to S-SN 403 via MN 402. The UEInformationResponse message includes the SPCR.

In operation 417A as shown in FIG. 9, UE 401 and S-SN 403 perform a UE information procedure via MN 402, e.g., as illustrated in the embodiments of FIG. 3. In particular, for instance, S-SN 403 may transmit UEInformationRequest message to MN 402. MN 402 may transfer the UEInformationRequest message to UE 401. Then, UE 401 may transmit UEInformationResponse message including a RLF-report to MN 402. MN 402 may transfer the UEInformationResponse message including the RLF-report to S-SN 403.

In operation 418 as shown in FIG. 9, MN 402 informs T-SN 404 that UE 401 has successfully completed the RRC reconfiguration procedure via a SgNB Reconfiguration Complete message, including the encoded a RRC response message, if received from UE 401.

After operation 418 as shown in FIG. 9, there may be different operations in following different embodiments.
(1) In some embodiments, in operation 419 as shown in FIG. 9, UE 401 performs a random access to T-SN 404. In operation 421 as shown in FIG. 9, after completing data forwarding from S-SN 403, MN 402 transmits UEContextRelease message to S-SN 403.
(2) In some other embodiments, in operation 419 as shown in FIG. 9, UE 401 performs a random access to T-SN 404. After the successful random access, UE 401 will transmit an indication to indicate that the trigger condition for a SPCR, e.g., associated with T304, has been met. In this case, T-SN 404 may transmit UEInformationRequest message to UE 401 after receiving the indication from UE 401. The UEInformationRequest message may include an indication to indicate that a SPCR should be reported. Then, UE 401 may transmit UEInformationResponse message to T-SN 404. The UEInformationResponse message may include the SPCR. T-SN 404 may transfer the reported information to MN 402. Then, MN 402 may forward the received information to S-SN 403 in a SN-initiated SN change procedure. Then, in operation 421 as shown in FIG. 9, after completing data forwarding from S-SN 403, MN 402 transmits UEContextRelease message to S-SN 403.

Details described in all other embodiments of the present application (for example, details regarding a MRO mechanism for a SPAR or a SPCR and SCG failure information procedure) are applicable for the embodiments of FIG. 9. Moreover, details described in the embodiments of FIG. 9 are applicable for all embodiments of FIGS. 1-6 and 8. It should be appreciated by persons skilled in the art that the sequence of the operations in exemplary procedure in the embodiments of FIG. 9 may be changed and some of the operations in exemplary procedure in the embodiments of FIG. 9 may be eliminated or modified, without departing from the spirit and scope of the disclosure.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments.

For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE) for wireless communication, comprising:
at least one memory; and
at least one processor coupled with the at least one memory and configured to cause the UE to:
receive, from a master node (MN), configuration information regarding a primary cell of a second cell group (PSCell) addition or change procedure, wherein the configuration information includes a trigger condition to transmit assistant information, and wherein the assistant information is related to successfully completing the PSCell addition or change procedure; and
transmit the assistant information to at least one of the MN, a source secondary node (SN), or a target SN, in response to successfully completing the PSCell addition or change procedure and in response to meeting the trigger condition.

2. The UE of claim 1, wherein the PSCell addition or change procedure includes at least one of:
a PSCell addition procedure;
a conditional PSCell addition (CPA) procedure;
a PSCell change procedure;
a MN initiated conditional PSCell change (CPC) procedure; or
a SN initiated CPC procedure.

3. The UE of claim 2, wherein, in response to the configuration information regarding at least one of the PSCell addition procedure, the CPA procedure, or the MN initiated CPC procedure:
a first threshold associated with a handover timer for the trigger condition is configured by the target SN; or
a second threshold associated with a physical layer problem timer for the trigger condition is configured by the MN; or
a third threshold associated with a timer for initiating failure recovery based on triggering measurement report for the trigger condition is configured by the MN.

4. The UE of claim 2, wherein, in response to the configuration information regarding the SN initiated CPC procedure:
a fourth threshold associated with a physical layer problem timer for the trigger condition is configured by the source SN; or
a fifth threshold associated with a timer for initiating failure recovery based on triggering measurement report for the trigger condition is configured by the source SN; or
a sixth threshold associated with a handover timer for the trigger condition is configured by the target SN; or
a seventh threshold associated with the physical layer problem timer for the trigger condition is configured by the MN; or
an eighth threshold associated with the timer for initiating failure recovery for the trigger condition is configured by the MN.

5. The UE of claim 4, wherein at least one of the fourth threshold, the fifth threshold, the sixth threshold, the seventh threshold, or the eighth threshold is a percent value of a timer length.

6. The UE of claim 4, wherein the trigger condition includes at least one of:
an elapsed time duration of the physical layer problem timer exceeds the fourth threshold multiplied by a length of the physical layer problem timer;
an elapsed time duration of the timer for initiating failure recovery exceeds the fifth threshold multiplied by the length of the timer for initiating failure recovery;
an elapsed time duration of the handover timer exceeds the sixth threshold multiplied by the length of the handover timer;
the elapsed time duration of the physical layer problem timer exceeds the seventh threshold multiplied by the length of the physical layer problem timer;
the elapsed time duration of the timer for initiating failure recovery exceeds the eighth threshold multiplied by the length of the timer for initiating failure recovery;
an expiry of the handover timer;
an expiry of the physical layer problem timer;
an expiry of the timer for initiating failure recovery; or
the elapsed time duration of the physical layer problem timer after initiating a secondary cell group (SCG) failure information procedure exceeds a ninth threshold multiplied by the length of the physical layer problem timer.

7. The UE of claim 1, wherein:
in response to the configuration information including the trigger condition to transmit the assistant information configured by the source SN, the configuration information including the trigger condition is received by the MN from the source SN via a SN change required message; or
in response to the configuration information including the trigger condition to transmit the assistant information configured by the target SN, the configuration information including the trigger condition is received by the MN from the target SN via a SN addition request acknowledge message.

8. The UE of claim 1, wherein the at least one processor is further configured to cause the UE to transmit, to the MN, first information indicating which trigger condition has been met in response to meeting at least one trigger condition in the configuration information.

9. The UE of claim 8, wherein the first information is carried in a radio resource control (RRC) reconfiguration complete message.

10. The UE of claim 8, wherein the first information includes at least one of:
second information indicating that a trigger condition related to a physical layer problem timer has been met for a successful PSCell addition report (SPAR) or a successful PSCell change report (SPCR), in response to meeting the trigger condition related to the physical layer problem timer; or
third information indicating that a trigger condition related to a timer for initiating failure recovery based on triggering measurement report has been met for the SPAR or the SPCR, in response to meeting the trigger condition related to the timer for initiating failure recovery.

11. The UE of claim 8, wherein the at least one processor is further configured to cause the UE to receive a request from the MN, and wherein the request includes information indicating that a successful PSCell addition report (SPAR) or a successful PSCell change report (SPCR) should be reported.

12. The UE of claim 11, wherein the assistant information is transmitted in a response to the MN, and the assistant information includes the SPAR or the SPCR.

13. The UE of claim 12, wherein the request is carried in a UE information request message, and wherein the response is carried in a UE information response message.

14. The UE of claim 1, wherein the at least one processor is further configured to cause the UE to transmit, to the target SN, information indicating that a successful PSCell addition report (SPAR) or a successful PSCell change report (SPCR) is available.

15. The UE of claim 14, wherein the at least one processor is further configured to cause the UE to:
receive a request for the SPAR or the SPCR from the target SN; and
transmit the SPAR or the SPCR to the target SN, in response to receiving the request from the target SN.

16. A processor for wireless communication, comprising:
at least one controller coupled with at least one memory and configured to cause the processor to:
receive, from a master node (MN), configuration information regarding a primary cell of a second cell group (PSCell) addition or change procedure, wherein the configuration information includes a trigger condition to transmit assistant information, and wherein the assistant information is related to successfully completing the PSCell addition or change procedure; and
transmit the assistant information to at least one of the MN, a source secondary node (SN), or a target SN, in response to successfully completing the PSCell addition or change procedure and in response to meeting the trigger condition.

17. The processor of claim 16, wherein the at least one controller is further configured to cause the processor to transmit, to the MN, first information indicating which trigger condition has been met in response to meeting at least one trigger condition in the configuration information.

18. A network node for wireless communication, comprising:
at least one memory; and
at least one processor coupled with the at least one memory and configured to cause the network node to:
transmit, to a user equipment (UE), configuration information regarding a primary cell of a second cell group (PSCell) addition or change procedure, wherein the configuration information includes a trigger condition to transmit assistant information, and wherein the assistant information is related to successfully completing the PSCell addition or change procedure; and
receive the assistant information from the UE in response to successfully completing the PSCell addition or change procedure and in response to meeting the trigger condition.

19. The network node of claim 18, wherein the PSCell addition or change procedure includes at least one of:
a PSCell addition procedure;
a conditional PSCell addition (CPA) procedure;
a PSCell change procedure;
a network node initiated conditional PSCell change (CPC) procedure; or
a source secondary node (SN) initiated CPC procedure.

20. A method performed by a user equipment (UE), the method comprising:
receiving, from a master node (MN), configuration information regarding a primary cell of a second cell group (PSCell) addition or change procedure, wherein the configuration information includes a trigger condition to transmit assistant information, and wherein the assistant information is related to successfully completing the PSCell addition or change procedure; and
transmitting the assistant information to at least one of the MN, a source secondary node (SN), or a target SN, in response to successfully completing the PSCell addition or change procedure and in response to meeting the trigger condition.
